(19) United States
(12) Patent Application Publication
(10) Pub. No.: US 2012/0068571 A1
(43) Pub. Date: Mar. 22, 2012

(54) CAPACITIVE MICROMACHINED ULTRASONIC TRANSDUCER

(75) Inventor: Jing-Kuang Chen, Taipei City (TW)

(73) Assignee: INDUSTRIAL TECHNOLOGY RESEARCH INSTITUTE, Hsinchu (TW)

(21) Appl. No.: 12/885,581

(22) Filed: Sep. 20, 2010

(51) Int. Cl. H02N 1/08

(52) U.S. Cl. 310/300

(57) ABSTRACT

A capacitive micromachined ultrasonic transducer (CMUT) is described, including a substrate, a conductive film disposed over the substrate, a conductive membrane suspended over the conductive film with a vacuum space underneath, and at least one anchoring post disposed under a middle of the conductive membrane and supporting the conductive membrane.

### BACKGROUND

1. Technical Field

This disclosure relates to structures of capacitive micromachined ultrasonic transducer (CMUT) having a large volumetric displacement.

2. Related Art

CMUT uses deformable membranes to transmit and receive ultrasound. When an AC signal with a proper DC bias is applied across the membrane and the counter electrode, the alternating electrostatic force drives the membrane to vibrate and generate ultrasound. The same CMUT also works as an ultrasound receiver. In the reception mode, the membrane is agitated by impinging ultrasound and changes the capacitance. With a DC bias, this change of capacitance generates an electrical signal, which carries the amplitude and phase information of the impinging ultrasound. A CMUT normally has a broader acoustic bandwidth than its piezoelectric counterpart and can be fabricated using IC processes. CMUT is a promising alternative for ultrasound transducers and is useful in medical imaging and nondestructive evaluation of material structures.

In the reception mode, a CMUT is sensitive to ultrasound frequency around the resonance frequency of the membrane but insensitive to the ultrasound in the rest of the spectrum. As a result, the mechanical structure of a CMUT generally is designed such that the fundamental mode of the membrane falls in the frequency window of interests to the application. The sensitivity of a CMUT as a receiver depends on the volumetric displacement of the membrane under a specific ultrasound pressure.

Taking a circular membrane of uniform thickness as an example; when its circumference is completely anchored, its resonance frequency is

$${f}_{n} = {\frac{{λ}_{n}^{2}}{2 π {r}_{o}^{2}} [ \frac{E {h}^{2}}{12 ρ ( 1 - {ν}^{2} )} ]}^{1 / 2} ∝ \frac{h}{{r}_{o}^{2}} , \qquad ( 1 )$$

wherein v is the Poisson's ratio, ρ is the density, E is the Young's modulus of the membrane material, h is the membrane thickness and rₒ is the radius of the membrane. Under a uniform pressure p, the center of the membrane is deformed by

$${W}_{c} = \frac{12 p {r}_{o}^{4} ( 1 - {ν}^{2} )}{64 E {h}^{3}} ∝ \frac{{r}_{o}^{4}}{{h}^{3}} = {( \frac{{r}_{o}^{2}}{h} )}^{2} \times \frac{1}{h} . \qquad ( 2 )$$

According to Eq. (1), at the same h/rₒ² ratio and the same resonance frequency, a smaller membrane (smaller radius r₁) is thinner (smaller thickness h₁) while a larger membrane (larger radius r₂) is thicker (larger thickness h₂). Therefore, according to Eq. (2), a thinner and smaller membrane has a larger central deformation (h₁<h₂→1/h₁>1/h₂) than its thicker and larger counterpart of the same fundamental frequency (the same h/rₒ² ratio). This concludes that for a higher reception sensitivity, a thinner and smaller membrane is preferred.

For most imaging and detection applications, due to the small aperture size, a transducer does not work alone, but multiple transducers are connected in an array to form an element as shown in FIG. 1. Each transducer 10 includes a dielectric layer 110 on a substrate 100, a conductive film 120, and a conductive membrane 140 suspended over the film 120 by anchoring walls 130 with a vacuum space 150 underneath. In such design, the spaces between the transducers 10 serve to accommodate release holes 160 and some of the anchoring walls 130. The spaces do not contribute to volumetric displacement in ultrasound transduction and limit the overall volumetric displacement of the element, especially when the frequency of the transducer gets higher so that the membrane area of each cell is reduced and more non-contributive spaces are needed. Though the non-contributive spaces can be reduced by forming a single large and thick membrane instead of multiple small and thin membranes, the volumetric displacement would still be limited due to the thickness of the large and thick membrane.

### SUMMARY

This disclosure provides structure designs of capacitive micromachined ultrasonic transducer (CMUT) that make larger overall volumetric displacements.

The CMUT according to an embodiment of this disclosure includes a substrate, a conductive film disposed over the substrate, a conductive membrane suspended over the conductive film with a vacuum space underneath, and at least one anchoring post disposed under the middle of the conductive membrane and supporting the conductive membrane.

The CMUT according to another embodiment includes a substrate having a V-shape cavity therein, a conductive film disposed over the substrate and in the V-shape cavity, and a conductive membrane suspended over the conductive film and in the V-shape cavity with a vacuum space underneath.

The CMUT according to still another embodiment includes a substrate, a corrugated conductive film over the substrate, and a corrugated conductive membrane suspended over and conformal with the conductive film with a vacuum space underneath.

In order to make the aforementioned and other objects, features and advantages of this disclosure comprehensible, a preferred embodiment accompanied with figures is described in detail below.

### BRIEF DESCRIPTION OF THE DRAWINGS

FIG. 1 illustrates a top view and a cross-sectional view of conventional CMUTs.

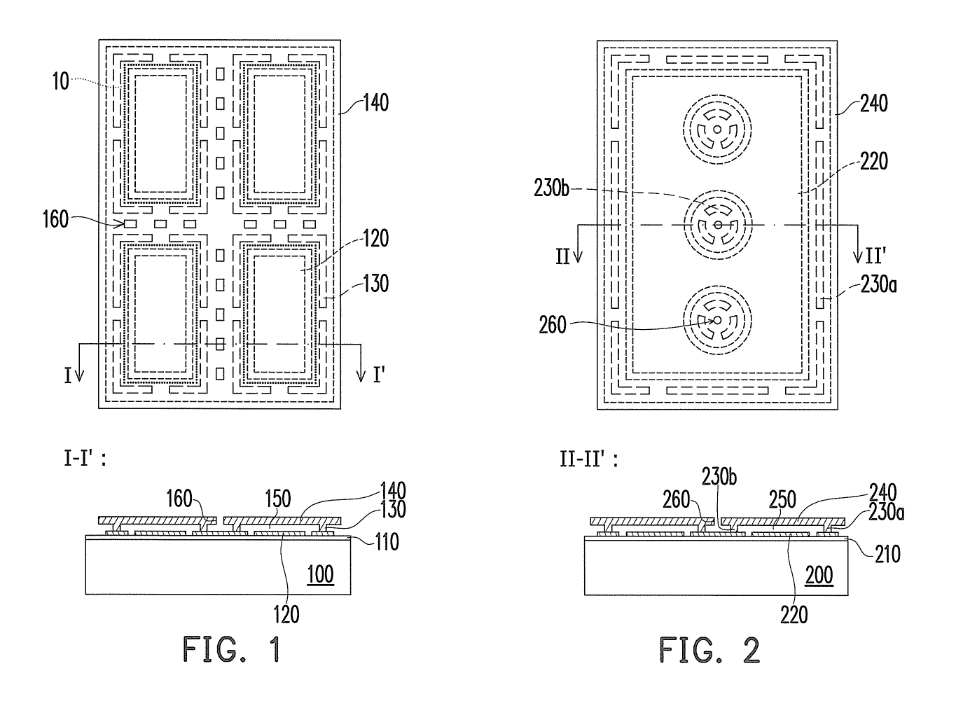

FIG. 2 illustrates a top view and a cross-sectional view of a CMUT according to a first embodiment.

FIGS. 3A-3B illustrate cross-sectional views of two CMUT structures according to a second embodiment and perspective views of the V-shaped cavities in the two CMUT structures.

FIG. 4 illustrates a cross-sectional view of a CMUT according to a third embodiment and a perspective view of the conductive film therein.

### DESCRIPTION OF EMBODIMENTS

### First Embodiment

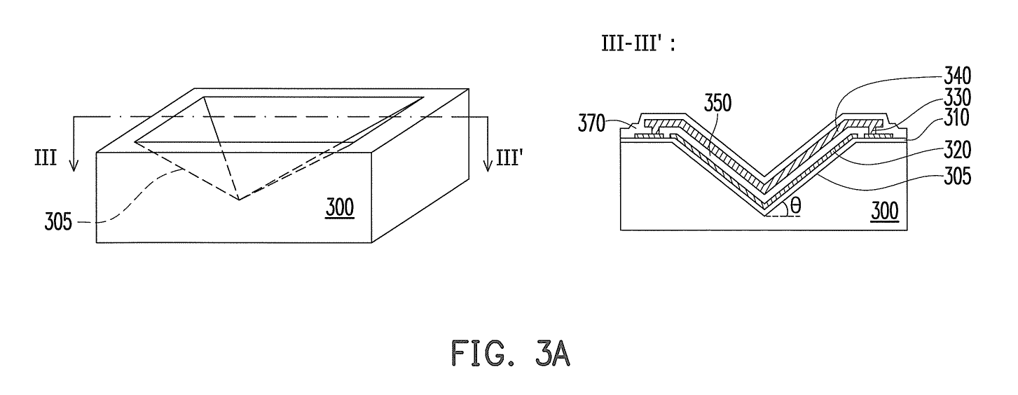

FIG. 2 illustrates a top view and a cross-sectional view of a CMUT according to the first embodiment.

Referring to FIG. 2, the CMUT includes a substrate 200, a dielectric layer 210 on the substrate 200, a conductive film 220 disposed on the dielectric layer 210, and a conductive membrane 240 suspended over the conductive film 220 by anchoring walls 230a and anchoring posts 230b with a vacuum space 250 underneath.

The anchoring walls 230a define the area of the CMUT. Each of the anchoring posts 230b is disposed under the middle of the conductive membrane 240 and supports the conductive membrane 240. The anchoring posts 230b may be hollow as illustrated, wherein each hollow anchoring post may surround a release hole 260 in the conductive membrane 240. The number of the anchoring posts 230b may be three as illustrated, or any other number larger than one. It is noted that the release holes 260 have been sealed after the release process that removes the sacrificial material under the conductive membrane 240 through the release holes 260 to form the vacuum space 250.

The anchoring walls 230a and the anchoring posts 230b may be formed from the same material. It is even possible that the anchoring walls 230a, the anchoring posts 230b and the conductive membrane 240 are all formed from the same material, such as doped polysilicon or germanium. The dielectric layer 210 may be a silicon oxide/silicon nitride/silicon oxide (ONO) composite layer. The conductive film 220 may include doped polysilicon or germanium or silicon carbide (SiC). In addition, the conductive film 220 may be defined in a manner such that the anchoring walls 230a and the anchoring posts 230b defined later are disposed on portions of the conductive film 220 that are separated from all the other portions of the conductive film 220, as shown in FIG. 2.

With the above structural design, the conductive membrane 240 can be made large and thin to have a large volumetric displacement. For example, the dimension of the conductive membrane 240 surrounded by the anchoring walls 230a may range from tens of square micrometers to about tens of thousands of square micrometers while the thickness of the same ranges from about tens of nanometers to tens of micrometers.

The anchoring posts 230b act as stationary nodes in the vibration to boost the resonance frequency of the element to the higher part of the spectrum and improve the volumetric displacement, and may also provide release holes 260 in their hollow forms such that a reasonable short release time is made. Thereby, a better electromechanical coupling efficiency is achieved. The frequency of ultrasound suitably detected by such CMUT ranges from sub-kHz to above 100 MHz.

### Second Embodiment

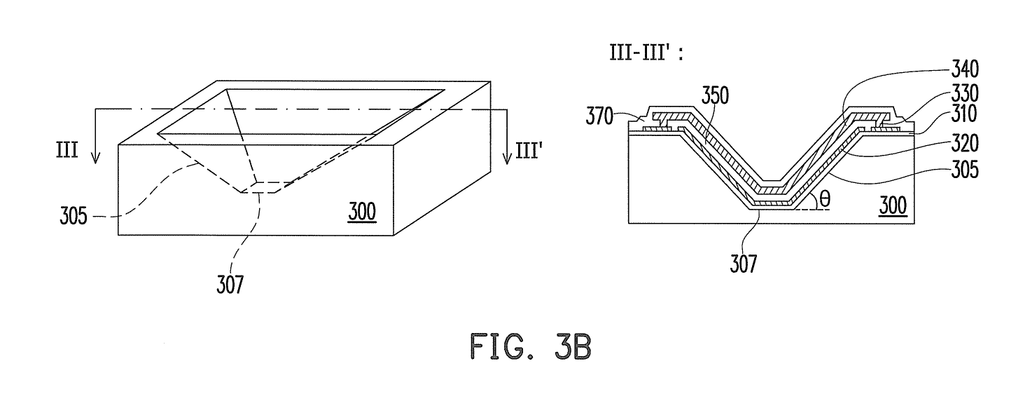

FIGS. 3A-3B illustrate cross-sectional views of two CMUT structures according to the second embodiment and perspective views of the V-shaped cavities of the two CMUT structures.

Referring to FIG. 3A, the CMUT structure includes a substrate 300 having a V-shape cavity 305 therein, a dielectric layer 310 disposed on the substrate 300 and in the V-shape cavity 305, a conductive film 320 disposed on the dielectric layer 310 and in the V-shape cavity 305, a conductive membrane 340 suspended over the conductive film 320 and in the V-shape cavity 305 by anchoring walls 330 with a vacuum space 350 underneath, and a polymer layer 370 covering the conductive membrane 340 for protecting the membrane from shorting to its ambient.

The materials of the dielectric layer 310, the conductive film 320, the anchoring walls 330 and the suspended conductive membrane 340 may refer to those mentioned in the 1^{st} embodiment. In addition, the anchoring walls 330 may be disposed on layers that are patterned along with the conductive film 320 and separated from the same.

Referring to FIG. 3B, the CMUT structure is different from that in FIG. 3A only in that the V-shape cavity 305 has a flat bottom 307 that has the effect of having a smaller plate area.

For each of the above two CMUT structures, the angle θ between each sidewall of the V-shape cavity 305 and the horizontal plane may range from be any value larger than 0° and smaller than or equal to 90°, preferably about 54.7°, to increase the volumetric displacement. The dimension of the conductive membrane 340 surrounded by the anchoring walls 330 may range from about tens of square micrometers to about tens of thousand of square micrometers while the thickness of the same ranges from about tens of nanometers to about hundreds of micrometers.

Each of the above CMUT structures according to the second embodiment provides larger volumetric displacement in some particular frequency domain, for example, in low-frequency domain. The frequency of ultrasound suitably detected by such CMUT ranges from about sub-kHz to about 100 MHz.

### Third Embodiment

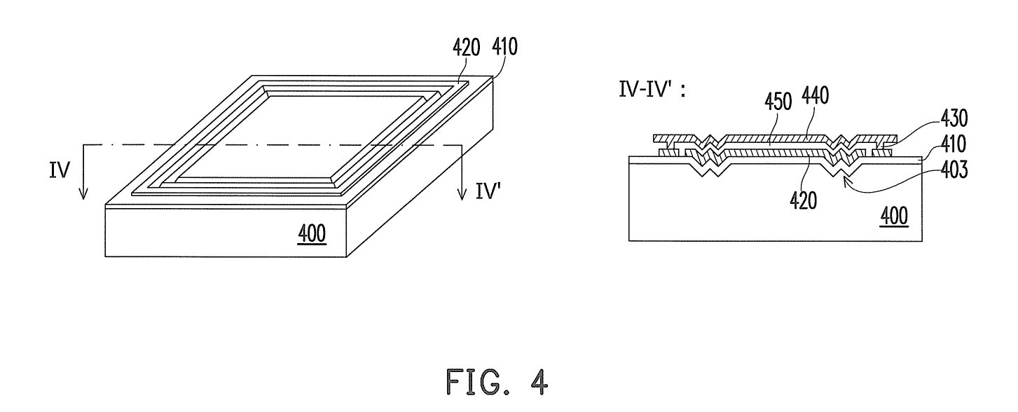

FIG. 4 illustrates a cross-sectional view of a CMUT according to the third embodiment and a perspective view of the conductive film therein.

Referring to FIG. 4, the CMUT includes a substrate 400 having a corrugated surface 403, a correspondingly corrugated dielectric layer 410 on the substrate 400, a correspondingly corrugated conductive film 420 on the dielectric layer 410, and a corrugated conductive membrane 440 suspended over and conformal with the conductive film 420 by anchoring walls 430a with a vacuum space 450 underneath. Accordingly, the corrugated surface 403 of the substrate 400 shapes the corrugated dielectric layer 410, the corrugated conductive film 420 and the corrugated conductive membrane 440.

The materials of the dielectric layer 410, the conductive film 420, the anchoring walls 430 and the conductive membrane 440 may refer to those mentioned in the 1^{st} embodiment. In addition, the anchoring walls 430 may be disposed on layers that are patterned along with the conductive film 420 and separated from the same.

The dimension of the conductive membrane 440 surrounded by the anchoring walls 430 may range from about tens of square micrometers to tens of thousands of square micrometers while the thickness of the same ranges from about tens of nanometers to about tens of thousand of micrometers.

The CMUT according to the third embodiment provides a larger electromechanical coupling efficiency in some particular frequency domain, e.g., in low frequency domain. The frequency of ultrasound suitably detected by such CMUT ranges from about sub-kHz to about 100 MHz.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A capacitive micromachined ultrasonic transducer (CMUT), comprising:
a substrate;
a conductive film disposed over the substrate;
a conductive membrane suspended over the conductive film, with a vacuum space underneath; and
at least one anchoring post disposed under a middle of the conductive membrane and supporting the conductive membrane.

2. The CMUT of claim 1, wherein the at least one anchoring post is hollow and surrounds a release hole in the conductive membrane.

3. The CMUT of claim 1, wherein the at least one anchoring post comprises three anchoring posts.

4. The CMUT of claim 1, further comprising:
a dielectric layer between the conductive film and the substrate.

5. The CMUT of claim 1, wherein the at least one anchoring post is disposed on a portion of the conductive film separated from all other portions of the conductive film.

6. The CMUT of claim 1, wherein the conductive membrane and the at least one anchoring post comprise the same material.

7. The CMUT of claim 6, wherein the conductive membrane and the at least one anchoring post both comprise doped polysilicon.

8. The CMUT of claim 1, wherein the substrate comprises Si, glass or polymer.

9. A capacitive micromachined ultrasonic transducer (CMUT), comprising:
a substrate having a V-shape cavity therein;
a conductive film disposed over the substrate and in the V-shape cavity; and
a conductive membrane suspended over the conductive film and in the V-shape cavity, with a vacuum space underneath.

10. The CMUT of claim 9, wherein the V-shape cavity has a flat bottom.

11. The CMUT of claim 9, wherein the V-shape cavity has a plurality of sidewalls, and an angle between each sidewall and a horizontal plane is about 54.7°.

12. The CMUT of claim 9, further comprising:
a dielectric layer between the conductive film and the substrate.

13. The CMUT of claim 9, further comprising:
a polymeric layer covering the conductive membrane.

14. The CMUT of claim 9, wherein the conductive membrane comprises doped polysilicon.

15. The CMUT of claim 9, wherein the substrate comprises Si, glass or polymer.

16. A capacitive micromachined ultrasonic transducer (CMUT), comprising:
a substrate;
a corrugated conductive film disposed over the substrate; and
a corrugated conductive membrane suspended over and conformal with the conductive film, with a vacuum space underneath.

17. The CMUT of claim 16, wherein the substrate has a corrugated surface that shapes the corrugated conductive film and the corrugated conductive membrane.

18. The CMUT of claim 16, further comprising:
a dielectric layer between the conductive film and the substrate.

19. The CMUT of claim 16, wherein the conductive membrane comprises doped polysilicon.

20. The CMUT of claim 16, wherein the substrate comprises Si, glass or polymer.
